(19) United States
(12) Patent Application Publication
(10) Pub. No.: US 2019/0132614 A1
(43) Pub. Date: May 2, 2019

(54) INFORMATION PROCESSING TERMINAL APPARATUS AND DISTRIBUTION APPARATUS

(71) Applicant: SONY CORPORATION, TOKYO (JP)

(72) Inventors: SHUNICHI KASAHARA, KANAGAWA (JP); TOMOHIRO TSUNODA, TOKYO (JP); TAKAHITO MIGITA, TOKYO (JP); KEI TAKAHASHI, TOKYO (JP)

(21) Appl. No.: 16/095,668

(22) PCT Filed: Feb. 28, 2017
(86) PCT No.: PCT/JP2017/007707

§ 371 Date: Oct. 22, 2018

(30) Foreign Application Priority Data
Apr. 28, 2016 (JP) 2016-090107

(51) Int. Cl. H04N 21/2187; H04N 21/234; H04N 21/2665; G06F 13/00

(52) U.S. Cl. CPC H04N 21/2187; H04N 21/234; G06Q 30/06; G06F 13/00; H04N 21/2665

(57) ABSTRACT

An information processing terminal apparatus for sending taken images and a distribution apparatus for controlling the distribution of taken images are provided. A display block 510 of a video providing apparatus image-synthesizes an archive video to be switched with a real-time video currently being taken and displays a synthesized video. Image processing such as edge processing or alpha blending may be executed on the archive video. A user of the video providing apparatus searches for a place at which the real-time video is superimposed on the archive video. Then, the distribution server executes switching to the archive video when sufficient superimposition is obtained.

### TECHNICAL FIELD

The present technology relates an information processing terminal apparatus for sending taken images and a distribution apparatus for controlling the distribution of taken images and to an information processing terminal apparatus for sending taken images of a real-estate property and a distribution apparatus for controlling the distribution of taken images of a real-estate property, for example.

### BACKGROUND ART

In signing the purchase or lease of an apartment room or a house, it is a general practice to go for a private view inside the property concerned in advance. However, the properties for which a customer desires to go for a private view are not always concentrated in one place, in which a customer is able to view only three to four properties a day, lowering the efficiency of private viewing.

For example, a real-estate property sale assist system was proposed in which a first database for storing the three-dimensional geometric data of real-estate properties and a second database for storing the interior information of the real-estate properties as three-dimensional geometric data are arranged as browsable via the Internet and, at the same time, the insides of real-estate properties are displayed as virtual spaces on the basis of the three-dimensional geometric data read from the first and second databases (refer to PTL 1 below, for example). According to this system, the insides of housing spaces can be presented to property purchasers as virtual spaces based on the housing-space three-dimensional geometric data and the housing-space interior information three-dimensional geometric data.

### CITATION LIST

### Patent Literature

[PTL 1]

JP 2001-195491A

### SUMMARY

### Technical Problems

Therefore, one object of the technology disclosed herein is to provide an information processing terminal apparatus for sending taken images and a distribution apparatus for controlling the distribution of taken images.

### Solution to Problems

The technology disclosed herein has been made taking such a problem as described above into consideration and according to a first aspect thereof, there is provided an information processing terminal apparatus. This information processing terminal apparatus has an image-taking block; a sending block configured to send an image taken by the image-taking block; and a control block, in which the control block controls alignment between a current image currently being taken by the image-taking block and a past image taken in the past.

According to a second aspect of the technology disclosed herein, the information processing terminal apparatus according the first aspect further has a display block. The control block is configured to make the display block display information for alignment with the past image.

According to a third aspect of the technology disclosed herein, the control block of the information processing terminal apparatus associated with the second aspect is configured to make the display block display the past image and the current image by superimposing the past image with the current image.

According to a fourth aspect of the technology disclosed herein, the control block of the information processing terminal apparatus associated with the second aspect is configured to make the display block display the past image on which any one of edge processing, alpha blending processing, or other image processing is executed by superimposing the past image with the current image.

According to a fifth aspect of the technology disclosed herein, the control block of the information processing terminal apparatus associated with the second aspect is configured to make the display block display information related with a travel locus at taking the past video.

According to a sixth aspect of the technology disclosed herein, there is provided a distribution apparatus. This distribution apparatus has a sending block configured to send an image taken by a first apparatus to a second apparatus; and a control block configured to control image transmission by the sending block, in which the control block controls distributed-image switching between a current image currently being taken and a past image taken in the past by the first apparatus.

According to a seventh aspect of the technology disclosed herein, the control block of the distribution apparatus associated with the sixth aspect is configured to control the distributed-image switching in accordance with a difference between the current image and the past image.

According to an eighth aspect of the technology disclosed herein, the control block of the distribution apparatus associated with the sixth aspect is configured not to execute the distributed-image switching until a difference between the current image and the past image gets within a predetermined range.

According to a ninth aspect of the technology disclosed herein, the control block of the distribution apparatus associated with the sixth aspect is configured to execute the distributed-image switching by interconnecting the current image and the past image by use of any one of snapping, image synthesis, or animation when a difference between the current image and the past image gets within a predetermined range.

### Advantageous Effects of Invention

According to a technology disclosed herein, an information processing terminal apparatus for sending a taken image and a distribution apparatus for controlling the distribution of a taken image can be provided.

It should be noted that the effects cited herein are illustrative only and therefore the effects of the present invention are not restricted thereto. Also, the present invention may bring about additional effects other than the effects described above.

Other objects, features, and advantages of the technology disclosed herein will be clarified by detail description based on embodiments to be described later and drawings attached hereto.

### BRIEF DESCRIPTION OF DRAWINGS

FIG. 1 is a diagram schematically illustrating a configurational example of a video viewing system 100 for viewing videos.

FIG. 2 is a diagram schematically illustrating a configurational example of a video viewing system 200 for viewing videos.

FIG. 3 is a diagram schematically illustrating a configurational example of a video viewing system 300 for viewing videos.

FIG. 4 is a diagram schematically illustrating a configurational example of a video viewing system 400 for viewing videos.

FIG. 5 is a diagram schematically illustrating a functional configuration of an information processing apparatus 500 capable of functioning as a video providing apparatus.

FIG. 6 is a diagram schematically illustrating a functional configuration of an information processing apparatus 600 capable of functioning as a video reproducing apparatus.

FIG. 7 is a diagram for describing a mechanism of viewing archive videos.

FIG. 8 is a diagram illustrating an example in which the video viewing system 100 is applied to the private viewing of real-estate properties.

FIG. 9 is a diagram illustrating another example in which the video viewing system 100 is applied to the private viewing of real-estate properties.

FIG. 10 is a diagram illustrating an example of a travel route at the time of imaging an archive video in a real-estate property.

FIG. 11 is a diagram illustrating an example in which a real-time video 1101 and an archive video 1102 are image-synthesized.

FIG. 12 is a diagram illustrating an example in which the information at the time of recording an archive video is displayed as superimposed in a real-time video currently being taken with a video providing apparatus.

FIG. 13 is a diagram illustrating an example in which a travel locus or a marker of a reproduction start position is displayed on an image of a map (a room layout diagram, for example).

FIG. 14 is a flowchart indicative of a processing procedure to be followed when a distribution server switches from the distribution of a real-time video to the distribution of an archive video.

FIG. 15 is a flowchart indicative of a processing procedure performed by the video providing apparatus when aligning a real-time video onto a video of a reproduction start position of an archive video.

### DESCRIPTION OF EMBODIMENTS

The following describes embodiments of a technology disclosed herein in detail with reference to attached drawings.

A. System Overview

A-1. System Configuration

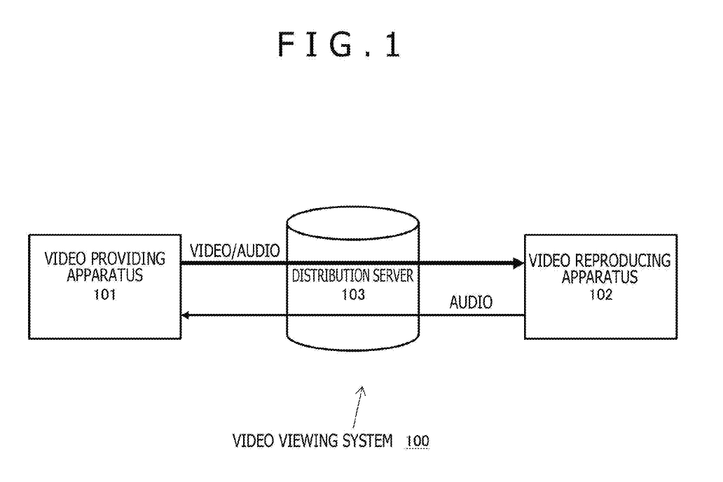

Now, FIG. 1 schematically illustrates a configurational example of a video viewing system 100 for viewing a video. The video viewing system 100 has one unit of video providing apparatus 101 for providing videos and one unit of video reproducing apparatus 102 for reproducing videos, which makes of one-to-one network topology. The video providing apparatus 101 and the video reproducing apparatus 102 are interconnected via a wireless or wired LAN (Local Area Network) or a wide area network such as the Internet.

The video providing apparatus 101 is an information terminal that is manipulated by a user (a privately viewing person or a sales person of a real-estate company) who is at a real-estate property (the site thereof). Alternatively, the video providing apparatus 101 may be a fixed-point camera installed at a site or a camera installed on a robot that autonomously operates at a site. Further, the video reproducing apparatus 102 is an information terminal and the like that is manipulated by a user (a prospective customer considering the purchase of a real-estate property or the contract of lease) who browses the information of properties at a place (for example, a real-estate shop or a home) away from the site without visiting it.

The video providing apparatus 101 has an image-taking block for taking videos (for example, viewpoint videos of a sales person at the site of a real-estate property) with the installation place of the video providing apparatus 101 being the viewpoint position and sends the taken videos to the video reproducing apparatus 102. For example, the image-taking block may include one all-sky camera. In this case, however, an all-sky video may not necessarily span 360 degrees; therefore, all-sky video may lack a part of field of view (this holds true with the following description).

The video providing apparatus 101 further may have an audio input block such as a microphone and multiplex the audio picked up at an image-taking site of an all-sky video with a video, thereby sending the multiplexed audio and video to the video reproducing apparatus 102. For example, a sales person at the site of a real-estate property may pick up the audio explaining the locational conditions and layouts of the property and send the picked up audio to the video reproducing apparatus 102.

In addition, the video providing apparatus 101 may have a display block. A display block (or the video providing apparatus 101 itself) is configured as a head-mounted display of transmission type, for example. A user at the site wears this head-mounted display around the head and takes images of the site and explains the property, while appropriately referencing videos displayed on the head-mounted display in a see-through manner.

On the other hand, the video reproducing apparatus 102 has a display block on which the video received from the video providing apparatus 101 is displayed. The video reproducing apparatus 102 (or the display block thereof) is configured as a head-mounted display that is worn by the user around the head so as to view the video, for example. For example, the video reproducing apparatus 102 clips a predetermined angle of view from an all-sky video (a video of the inside of a real-estate property) taken with the video providing apparatus 101 and displays the clipped angle of view. Alternatively, the video reproducing apparatus 102 may be configured as a dome-type display so as to display the entire all-sky video that is taken at the place where video providing apparatus 101 is installed. For details of a dome-type display, refer to Japanese Patent Application No. 2015-245710, description already assigned to the applicant hereof, for example. Alternatively, the video reproducing apparatus 102 may also be an ordinary (or a large screen) monitor display.

The video reproducing apparatus 102 may have an audio output block such as a speaker or a headphone so as to reproducingly output audio (for example, the audio of a sales person at the site of a real-estate property who is explaining the locational conditions and layouts) sent from the video providing apparatus 101 as multiplexed with video along with the video.

Further, the video reproducing apparatus 102 may further has an audio input block such as a microphone through which to input user audio instructions. For example, the user of the video reproducing apparatus 102 is able to input audio instructions such as “I want to see the scenery from the veranda,” “Show me the living room,” and so on. Such instructions are sent to the video providing apparatus 101.

It is also practicable to provide direct communication between the video providing apparatus 101 and the video reproducing apparatus 102; however, the mediation of a distribution server 103 is assumed in the description below. The video providing apparatus 101 sends an all-sky video taken at the site to the distribution server 103 once. The distribution server 103 sends the all-sky video or a predetermined view angle video clipped from the all-sky video to the video reproducing apparatus 102. Also, the distribution server 103 archives the video received from the video providing apparatus 101.

The video viewing system 100 illustrated in FIG. 1 configures a one-to-one network topology with one video providing apparatus 101 and one video reproducing apparatus 102. For example, this configuration corresponds to an embodiment in which a video taken with one video providing apparatus 101 installed at a particular property is viewed with one video reproducing apparatus 102 installed at a real-estate shop. Since a customer can view properties with a real-time video with nearly a real feeling even without visiting the sites, efficient private viewing can be realized, thereby enhancing customer satisfaction.

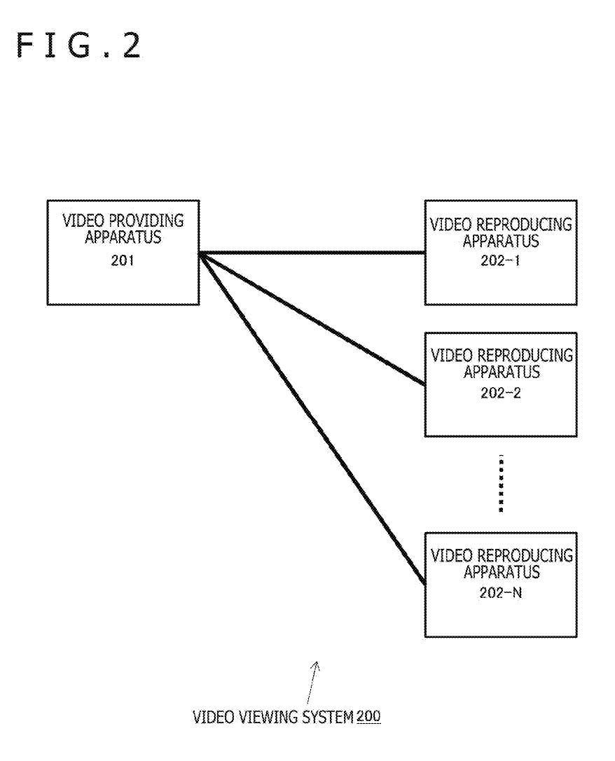

By contrast, FIG. 2 through FIG. 4 illustrate variations to the video viewing system 100 for viewing all-sky videos. It should be noted that, in each of the diagrams, the distribution server is omitted from illustration; however, in any case, it should be understood that the distribution server is arranged between the video providing apparatus and the video reproducing apparatus.

The video viewing system 200 illustrated in FIG. 2 configures a one-to-N network topology with one video providing apparatus 201 and plural (N units of) video reproducing apparatuses 202-1, 202-2, . . . , 202-N, in which an all-sky video taken with one video providing apparatus 201 (the same video taken in the same line-of-sight direction at the same viewpoint position) is viewed with the video reproducing apparatuses 202-1, 202-2, . . . 202-N at the same time. For example, this configuration corresponds to an embodiment in which the video of a particular property taken with one video providing apparatus 201 installed at the property is viewed with plural video reproducing apparatuses 202-1, 202-2, . . . , 202-N installed at a real-estate shop (or installed at each of two or more branches of a real-estate company). Since the real-time video of one property can be viewed by two or more customers in a shared manner, efficient private viewing can be realized for a real-estate company.

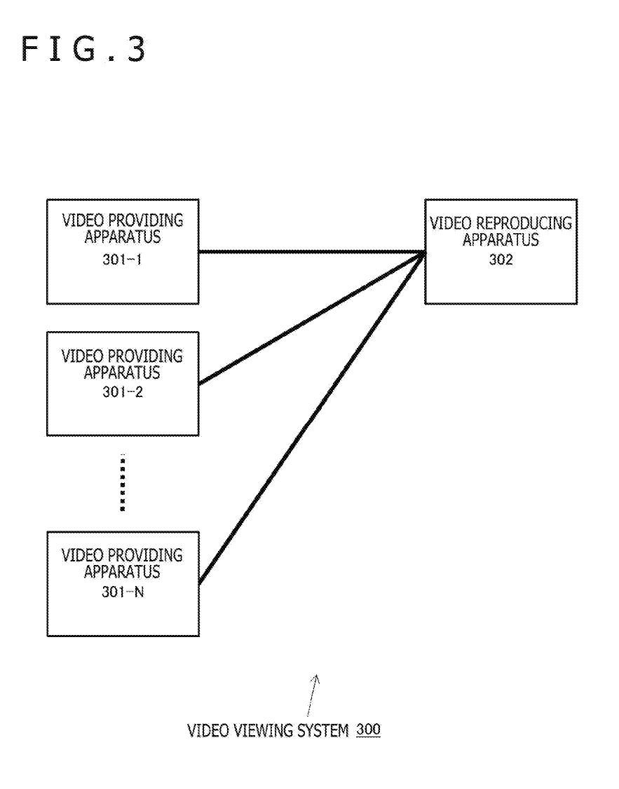

A video viewing system 300 illustrated in FIG. 3 configures a N-to-one network topology with plural (N units of) video providing apparatuses 301-1, 301-2, . . . 301-N and one video reproducing apparatus 302, in which one video reproducing apparatus 302 receives and displays a video selectively from any one of the video providing apparatuses 301-1, 301-2, . . . 301-N installed at different places. It is assumed that the video reproducing apparatus 302 be capable of dynamically switching between the video providing apparatuses 301-1, 301-2, . . . 301-N from which videos are sent. When the video providing apparatus 301 that is a video source is selected, the viewpoint position of a video that is reproduced (viewable) with the video reproducing apparatus 302 is switched (the viewpoint position instantaneously moves to the installation place of the selected video providing apparatus 301). Further, it is assumed that the video reproducing apparatus 302 be capable of instructing the selected video providing apparatus 301 to switch between line-of-sight directions. For example, this configuration corresponds to an embodiment in which one video reproducing apparatus 302 installed at a real-estate shop views in a switching manner the videos sent from the plural video providing apparatuses 301-1, 301-2, . . . 301-N installed at two or more properties. Alternatively, an embodiment is also assumed that the videos from the plural video providing apparatuses 301-1, 301-2, . . . 301-N installed in rooms of one real-estate property are viewed in a switching manner with the video reproducing apparatus 302. Since customers are able to view the real-time video of each property at once even without visiting each property with nearly a real feeling, thereby realizing efficient private viewing and, at the same time, enhancing customer satisfaction.

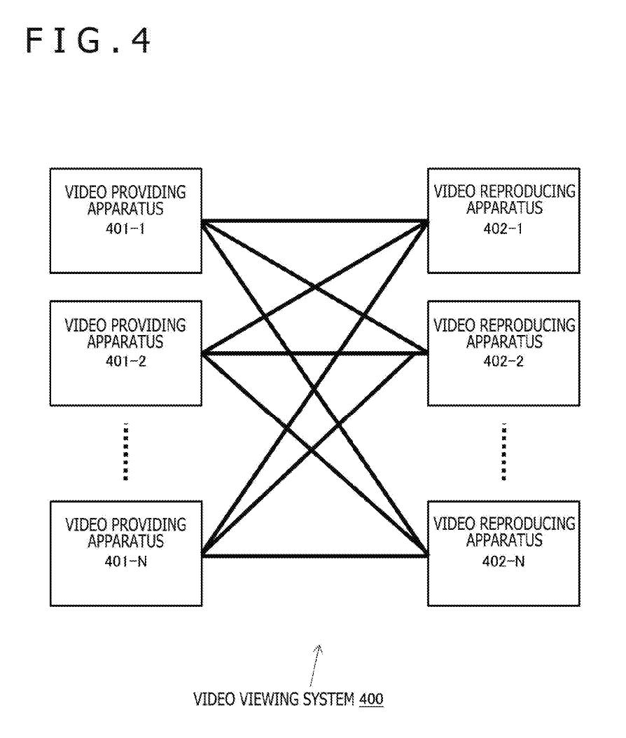

Further, a video viewing system 400 illustrated in FIG. 4 configures an N-to-N network topology with plural (N units of) video providing apparatuses 401-1, 401-2, . . . , 401-N and plural (N units of) video reproducing apparatuses 402-1, 402-2, . . . , 402-N. The N-to-N network topology can include the one-to-one network illustrated in FIG. 1, the one-to-N network illustrated in FIG. 2, and the N-to-one network illustrated in FIG. 3. For example, this configuration corresponds to an embodiment in which each of the plural video reproducing apparatuses 402-1, 402-2, . . . , 402-N installed at a real-estate shop (or at two or more branches of a real-estate company) views the videos from the plural video providing apparatuses 401-1, 401-2, . . . , 401-N installed at two or more properties by switching between the videos. Since customers are able to view the real-time video of each property at once even without visiting each property with nearly a real feeling, thereby realizing efficient private viewing and, at the same time, enhancing customer satisfaction.

While an all-sky video is provided by the video providing apparatus, the video reproducing apparatus side may, if a video in any one of line-of-sight directions, rather than all skies, is viewed, define the line-of-sight direction in which a video is viewed with the video reproducing apparatus as “audiovisual data,” thereby managing the audiovisual data with a distribution server in a concentrated manner. In addition, if an all-sky video from one video providing apparatus is viewed with two or more video reproducing apparatuses as illustrated in FIG. 2 and FIG. 4, the audiovisual data of each video reproducing apparatus may be shared for mutual use. Further, in distributing an archive video from a distribution server, summary results of the past audiovisual data may be used.

B. Apparatus Configuration

B-1. Configuration of the Video Providing Apparatus

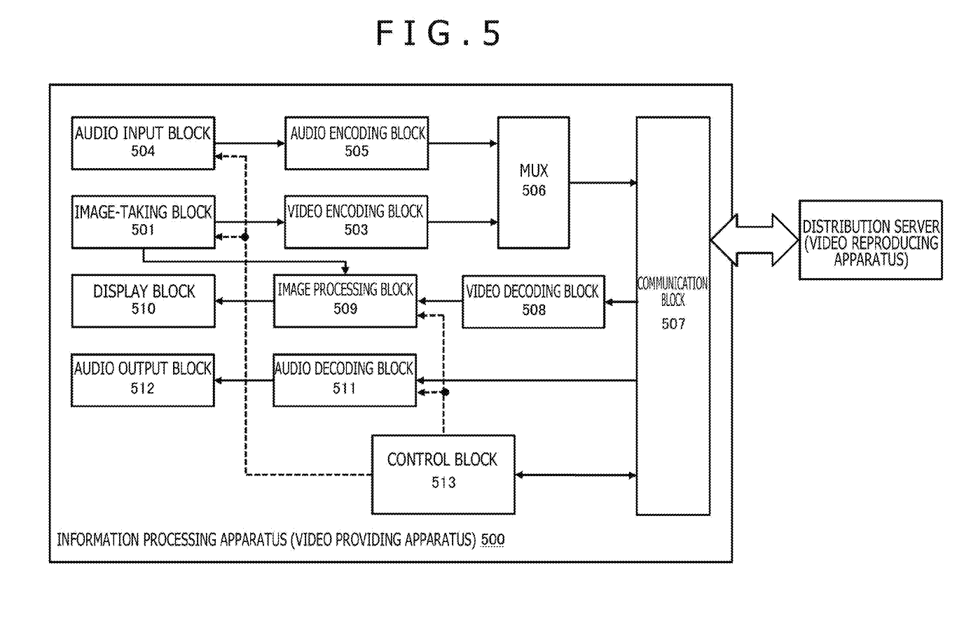

FIG. 5 schematically illustrates a functional configuration of an information processing apparatus 500 that is functional as a video providing apparatus in the video viewing systems 100 through 400. The illustrated information processing apparatus 500 has an image-taking block 501, a video encoding block 503, an audio input block 504, an audio encoding block 505, a multiplexing (MUX) block 506, a communication block 507, a video decoding block 508, an image processing block 509, a display block 510, an audio decoding block 511, an audio output block 512, and a control block 513. The following describes the components 501 through 513.

The image-taking block 501 includes a monocular camera (including a wide-angle camera and a fish-eye camera), a binocular stereo camera, a multi-eye all-sky camera, or the like. Use of a stereo camera gives the feeling of depth to a video. The image-taking block 501 takes images of surroundings with a place of installation of the information processing apparatus 500 being a viewpoint position. The video encoding block 503 executes encoding processing on the video signal taken by the image-taking block 501. The video taken by the image-taking block 501 is distributed to a video reproducing apparatus as a real-time video (via a distribution server) or recorded as an archive video in the distribution server.

The audio input block 504including a small-size microphone, stereo microphone, or the like, for example, can pick up the audio at an image-taking site of an all-sky video by arranging along with the image-taking block 501. Use of a stereo microphone can stereoscopically reconfigure the sound at the time of sound pickup on the reproducing side (namely, a video reproducing apparatus). The audio encoding block 505 executes encoding processing on the audio signal inputted through the audio input block 504.

The multiplexing (MUX) block 506 multiplexes an encoded video signal and an encoded audio signal that are encoded by the video encoding block 503 and the audio encoding block 505, respectively, and forms the resultant multiplexed signal into a signal format (a packet) for the transmission to a video reproducing apparatus via a distribution server.

The display block 510 (or the entire video providing apparatus 500) is configured as a transmission-type head-mounted display, for example. Alternatively, the display block 510 (or the entire video providing apparatus 500) is configured as a portable information terminal (with a camera) such as a smartphone or a tablet. The display block 510 displays, in an overlay manner, a video to the field-of-view of a user taking the video of a property at a site. The video decoding block 508 decodes an archive video received from a distribution server, for example. The image processing block 510 executes image recognition and other processing operations in an image taken with the image-taking block 501 or the video decoded with the video decoding block 508 so as to generate a video to be displayed on the display block 510. The display block 510 displays, to the user, such guidance information as a visiting destination and a visiting route, for example.

The audio decoding block 511 decodes the encoded audio signal received from a video reproducing apparatus, for example. The audio output block 512 audibly outputs a decoded baseband audio signal. For example, audio instructions such as “I want to see the scenery from the veranda” or “Show me the living room” by a user of the video reproducing apparatus are audibly outputted at a site.

The communication block 507 executes mutual communication like the transmission of video and audio with a video reproducing apparatus. However, the communication with a video reproducing apparatus requires the mediation of a distribution server (as described above). The communication block 507 executes mutual communication with a video reproducing apparatus, a distribution server, and other external apparatuses via a wireless or wired LAN or a wide-area network such as the Internet.

The control block 513 controls the operations of the components 501 through 512 in an overall manner. For example, the control block 513 executes the processing of realizing real-time communication with a video reproducing apparatus (or a viewing group) to which video is sent and the processing of a video to be displayed to a user (a person taking a video of the property at the site) at the display block 510. Further, in order to restrict the range of the information to be provided in accordance with the attribute information of a video reproducing apparatus (or a viewing group) to which a video is sent, the control block 513 executes turn on/off of an image-taking operation or an audio input operation, mosaic or masking processing on a taken video, and input audio modulation processing.

B-2. Configuration of the Video Reproducing Apparatus

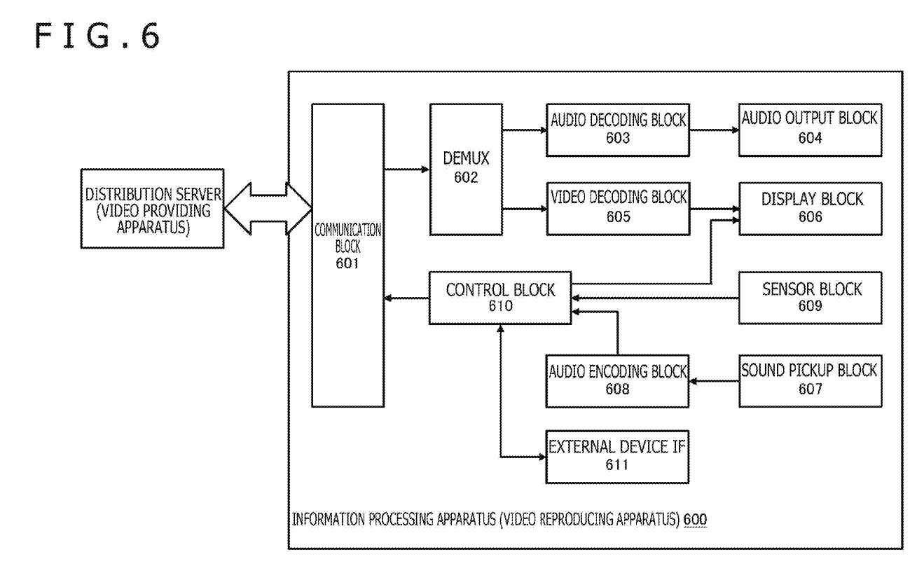

FIG. 6 schematically illustrates a functional configuration of an information processing apparatus 600 that is functional as a video reproducing apparatus in the video viewing systems 100 through 400. The illustrated information processing apparatus 600 has a communication block 601, a demultiplexer (DEMUX) 602, an audio decoding block 603, an audio output block 604, a video decoding block 605, a display block 606, a sound pickup block 607, an audio encoding block 608, a sensor block 609, a control block 610, and an external device interface 611. The following describes the components 601 through 611.

The communication block 601 executes mutual communication like the transmission of video and audio with a video providing apparatus. As requires, communication with a distribution server (described above) is executed via the communication block 601. The communication block 601 executes mutual communication with a video providing apparatus, a distribution server, and other external apparatuses via a wireless or wired LAN or a wide-area network such as the Internet, for example.

For example, a send start request for video and audio is sent from the communication block 601 to a video providing apparatus installed at a place where a user wants to view the video (for example, a real-estate property to be privately viewed). Then, a transmission signal formed into a predetermined signal format (a packet) is received by the communication block 601 from the video providing apparatus. In addition, while a video received from a certain video providing apparatus is being displayed (namely, being viewed by a user), if the user wants to see in a different line-of-sight direction at that viewpoint position, a line-of-sight direction change request is sent from the communication block 601. Further, if the user wants to switch the current video to a video sent from another video providing apparatus, a send stop request is sent to the video providing apparatus receiving video and audio from the communication block 601 and, at the same time, a send start request is sent to a video providing apparatus to be switched from the communication block 601.

The demultiplexer (DEMUX) 602 separates a multiplexed signal sent from a video providing apparatus into an encoded video signal and an encoded audio signal and distributes these signals to the audio decoding block 603 and the video decoding block 605, respectively.

The audio decoding block 603 decodes the encoded audio signal to generate a baseband audio signal and audibly outputs the generated signal from the audio output block 604. The audio output block 604 includes a monaural, stereo, or multi-channel speaker, for example.

The video decoding block 605 decodes the encoded video signal so as to generate a baseband video signal, thereby displaying the video taken with the video providing apparatus from which the encoded video signal was received onto the display block 606. The display block 606 (or the information processing apparatus 600 main) includes a head-mounted display, a dome-type display, or a large-screen (or normal-screen) monitor display.

The sound pickup block 607 including a small-size microphone, a stereo microphone, or the like, for example, picks up user audio and so on. The audio encoding block 608 encodes an audio signal entered through the sound pickup block 607 and outputs the encoded audio signal to the control block 610. The user audio may include impressions and admirations to a video displayed on the display block 606 and audio instructions (for example, the change of line-of-sight directions of all-sky video) to the control block 610 (or the video reproducing apparatus).

A user of a video reproducing apparatus can issue audio instructions such as “I want to see the scenery from the veranda,” “Show me the living room,” and so on, while viewing the video of the real-estate property to be privately viewed on the display block 606, for example. This user audio is picked up through the sound pickup block 607 to be encoded by the audio encoding block 608, the encoded user audio being subsequently sent from the communication block 601 to the video providing apparatus.

The control block 610 controls the outputs of the video and audio received from the video providing apparatus. In addition, the control block 610 controls the displaying of UI and OSD (On-Screen Display) for the screen of the display block 606 and processes user (viewer) manipulations done on UI and OSD.

The sensor block 609 measures the line-of-sight direction, head position, or attitude of a user (a viewer who views a video displayed on the screen of the display block 606). The sensor block 609 is configured by a combination of two or more sensor devices such as a gyro sensor, an acceleration sensor, and a geomagnetic sensor, for example (sensors that can detect a total of nine axes of a three-axis gyro sensor, a three-axis acceleration sensor, and a three-axis geomagnetic sensor, for example). The sensor block 609 may be integrated with the information processing apparatus 600 main body (a head-mounted display or the like) or may be an accessory part that is externally attached to the main body.

User operations such as a line-of-sight direction, a head position, or an attitude (or not only the head but also gesture operations using the body and the hands and the legs) that are detected by the sensor block 609 may be manipulations done on UI and OSD displayed on the display block 609 or instructions of view angles to be displayed on the display block 609 in an all-sky video. For example, the shaking and nodding of the user head (or looking right and left and up and down) can be handled as the instructions of changing the line-of-sight directions in an all-sky video. Further, user operations of tilting forward and backward of the body may be handled as a camera zooming manipulation in the current line-of-sight direction (zooming in is realized by the forward tilting and zooming out is realized by the backward tilting). Then, the results of the detection by the sensor block 609 are outputted to the control block 610.

On the basis of the change in the user line-of-sight direction, shaking and nodding of the head (looking right or left and up and down), or attitude detected by the sensor block 609, the control block 610 sends an instruction of change in the line-of-sight direction in which to view an all-sky video being received through the communication block 601. In addition, the control block 610 sends a user audio instruction picked up with the sound pickup block 607 to the video providing apparatus via the communication block 601 without change or after converting this audio instruction into text information or command information.

Further, if user operations of line-of-sight direction, head, and attitude (or not only the head but also gesture operations using the body and hands and legs) are manipulations done on the UI and OSD on the screen, then the control block 610 executes the processing on the display video of the display block 606 in accordance with these manipulations.

The external device interface (IF) 611 connects external devices to the information processing apparatus 600 in accordance with interface standards such as USB (Universal Serial Interface) and so on. For example, the information processing apparatus 600 is capable of connecting known input devices (not depicted) such as a keyboard and a mouse, a touch panel, a joystick, a game controller and so on to the external device interface 611. These types of input devices may be used for inputting manipulations done on UI and OSD on the screen of the display block 606 and for issuing instructions for moving positions at which an all-sky video is taken and switching between line-of-sights.

C. Viewing Archive Video

In item A mentioned above, a mechanism by which a real-time video taken real-time with a video providing apparatus was viewed with the video reproducing apparatus was described. By contrast, an embodiment is also practicable in which a video taken with a video providing apparatus is recorded to an external apparatus (a distribution server) once and the video reproducing apparatus side views the archive video received from the external apparatus.

Reasons why archive videos are viewed are various. For example, there are cases in which customers desire to make confirmation of properties in time zones that are different from the time of viewing as with the case in which, since a customer is busy in the daytime and therefore can visit a real-estate shop only in the evening, the customer privately views properties by viewing the archive videos of properties taken in the daytime beforehand or, conversely, the case in which customers who viewed the daytime real-time videos of properties want to see the nighttime sceneries thereof, for example. Further, there may be the case in which customers desire to view the videos of properties taken in different natural conditions such as rain. In addition, customers may view the videos of properties taken in different seasons in the same time zone. Alternatively, there may be the case in which, as with popular properties, accesses from many video reproducing apparatuses are concentrated to a particular video providing apparatus, thereby allowing the transmission of real-time videos to not all video reproducing apparatuses due to limited transmission band.

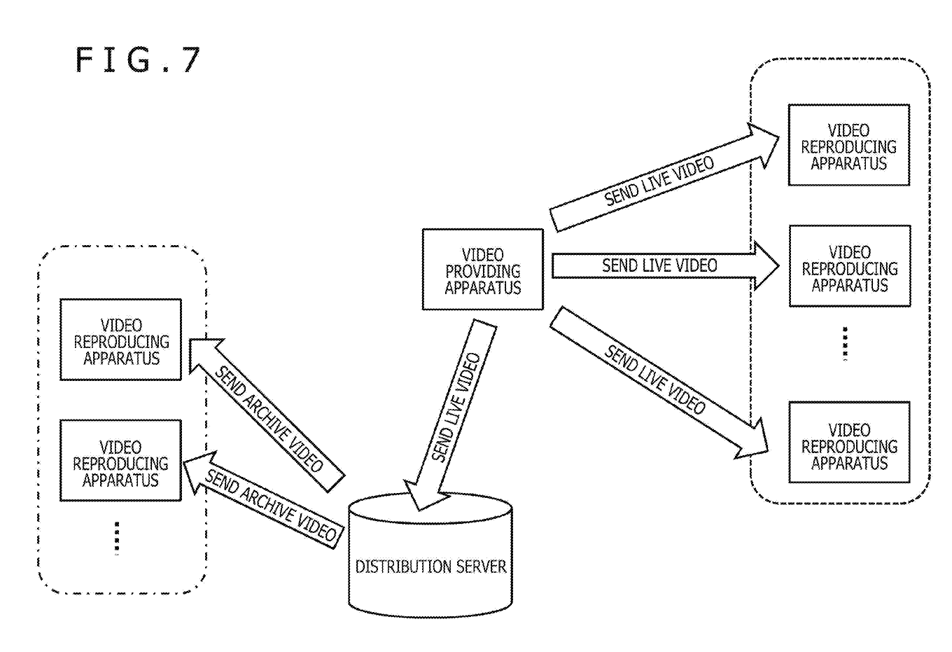

FIG. 7 illustrates a mechanism by which real-time videos are not sent from a video providing apparatus directly to video reproducing apparatuses, but archive videos recorded to an external apparatus are distributed to video reproducing apparatuses.

An external apparatus as referred to here denotes, for example, a distribution server installed physically independently of a video providing apparatus so as to record videos or distribute the recorded videos. By letting a distribution server do the video distribution to the video reproducing apparatuses excluded as excess apparatuses at the time or in the time zone specified by the video reproducing apparatus side, the load of the video providing apparatus can be dispersed. Further, although the video reproducing apparatuses excluded as excessive is not allowed the live viewing of videos taken at the place (the viewpoint position) of installation of a video providing apparatus, but these videos can be relived as long as a time delay permits.

A real-time video taken with each video providing apparatus is also sent to a distribution server. The distribution server records the received video as linked with the information for identifying the video providing apparatus from which the video was received or the information for identifying the image-taking viewpoint position (the property in which the video providing apparatus is installed or the room inside the property), the time zone in which the video was taken, and the environment in which the video was taken. When a send start request for the instruction for switching between image-taking environments such as time zone, season, and weather comes from a video reproducing apparatus, the sending of the real-time video from the video providing apparatus is switched to the sending of the archive video recorded to an external apparatus.

D. Private Viewing of Real-Estate Properties

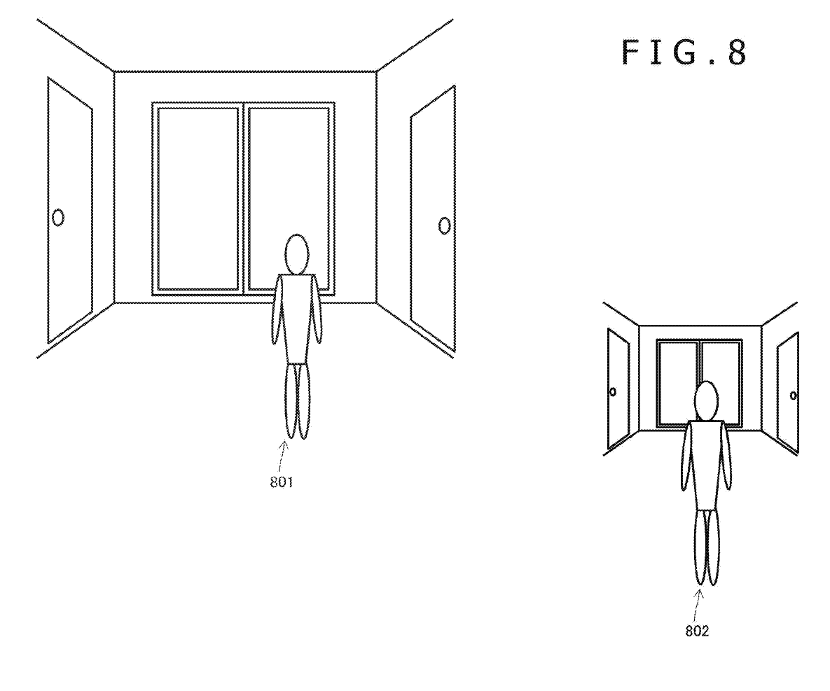

FIG. 8 illustrates an example in which the video viewing system 100 is applied to the private viewing of real-estate properties. Reference numeral 801 is indicative of a user (a person privately viewing properties or a sales person of a real-estate company) who is at a real-estate property (a local site), this user having or wearing a video providing apparatus (described above). On the other hand, reference numeral 802 is indicative of a user who does not visit a local site but browses the information associated with properties from a place away from the local site (for example, a shop of a real-estate company or the home), viewing the video of a properties taken with the video providing apparatus by use of the video reproducing apparatus (described above).

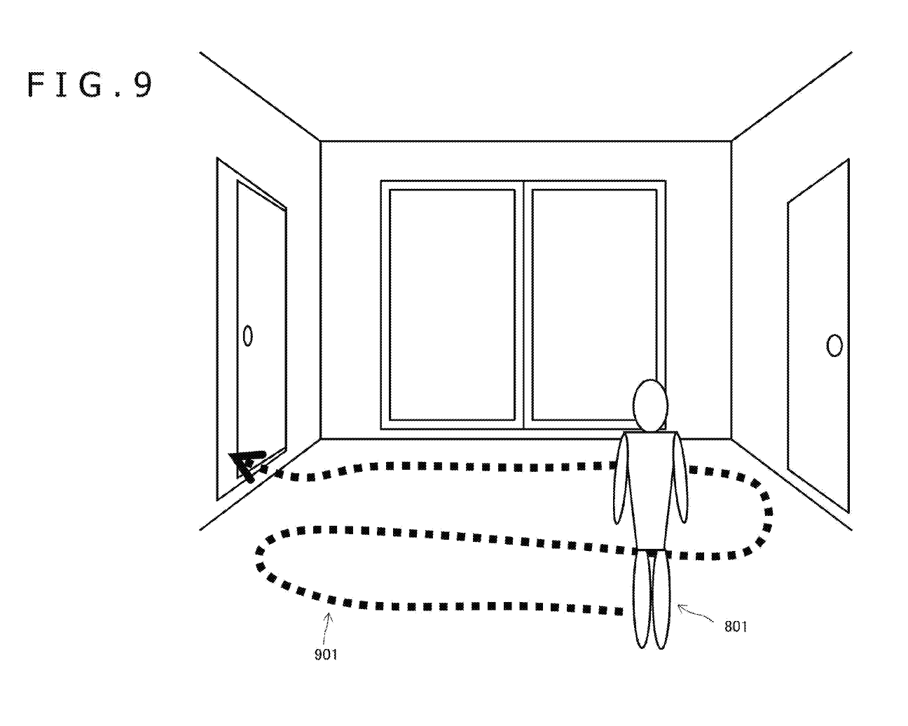

As indicated with reference numeral 901 depicted in FIG. 9, while walking around properties, the user 801 explains the locational conditions and layouts of properties and facilities and talks about the impressions and, further, opens doors to walk into other rooms. Since the user 802 can view, with nearly actual feeling, the real-time video of properties even without visiting the local site, the user 802 can realize efficient private viewing. That is, applying the video viewing system 100 to private viewing enhances customer satisfaction.

E. Switching Between Real-Time Video and Archive Video

For modes in which to view video on the video reproducing apparatus side, viewing a real-time video taken real-time with a video providing apparatus and viewing an archive video recorded once in a distribution server or the like can be mentioned.

Reasons why archive videos are viewed are various. For example, there are cases in which customers desire to make confirmation of properties in time zones that are different from the time of viewing as with the case in which, since a customer is busy in the daytime and therefore can visit a real-estate shop only in the evening, the customer privately views properties by viewing the archive videos of properties taken in the daytime beforehand or, conversely, the case in which customers who viewed the daytime real-time videos of properties want to see the nighttime sceneries thereof, for example. Further, there may be the case in which customers desire to view the videos of properties taken in different natural conditions such as rain. In addition, customers may view the videos of properties taken in different seasons in the same time zone. Alternatively, there may be the case in which, as with popular properties, accesses from many video reproducing apparatuses are concentrated to a particular video providing apparatus, thereby allowing the transmission of real-time videos to not all video reproducing apparatuses due to limited transmission band.

Switching from real-time video to archive video may be instructed from any one of a video providing apparatus and a video reproducing apparatus. For example, if the user of a video providing apparatus at a local site such as a sales person of a real-estate company wants to show a video of a property concerned taken in another time zone, the user gives an instruction for switching to an archive video. Further, if, during viewing the real-time video of a property being taken with the video providing apparatus, the user of a video reproducing apparatus wants to see how the property concerned looks in different time zones or different seasons, the user gives an instruction to switch to an archive video. If, with the same property, an archive video for each time zone or each season can be recorded to a distribution server and streamed to a video reproducing apparatus, the video reproducing apparatus side may display such icons for selecting archive videos as “morning,” “noon,” “evening,” “spring,” “summer,” “autumn,” and “winter,” for example, thereby requesting for the switching from real-time video to archive video.

If, in switching from real-time video to archive video, the current video-taking position of a video providing apparatus for imaging a real-time video is remote from the video-taking position of the archive video, the videos are switched discontinuously and therefore unnaturally, thereby losing the reality in video. Also, the user viewing such videos may feel dizzy when the videos are changed discontinuously.

For example, if the video-taking position for a real-time video and the video-taking position of an archive video are away from each other by only several tens of centimeters at the timing of switching, then video continuous switching is enabled by snapping, image synthesis (if three-dimensional measurement is enabled, the videos are three-dimensionally re-synthesized), or animation or the video discontinuity is within an allowable range for a viewer. However, attempting to switch to a video taken at a video-taking position remote by several meters makes it impracticable to continuously switch between videos by image synthesis and, at the same time, makes the video discontinuity beyond an allowable range for a viewer.

In switching from real-time video to archive video, it is desired to keep the continuity between scenes by switching from a real-time video taken at the video-taking position matching (or within a predetermined distance from) the video-taking position at which an archive video was taken.

Likewise, in switching from an archive video to a real-time video again, it is also desired that switching takes place with a real-time video taken at a video-taking position matching (or within a predetermined distance from) the video-taking position at which the viewing of an archive video ends. That is, ending the reproduction of an archive video requires the user 801 (the video providing apparatus) to move to the video-taking position at the time of the end of reproduction and wait there.

It should be noted that the video-taking position referred to here is desirably not only a horizontal position but also a vertical position. This is because, if there is a match in the horizontal position but there is a large mismatch in the vertical position, watching the same object in a room gives impressions of discontinuous video switching depending on looking-up or looking-down angles.

Further, taking an all-sky video requires the assurance of the matching of video-taking positions; however, the matching of video-taking directions can be corrected, thereby making the assurance unnecessary. With an all-sky video, the correction of roll and pitch is enabled; however, only the yaw-axis position need be manually adjusted by the user 801, namely, the person taking a video.

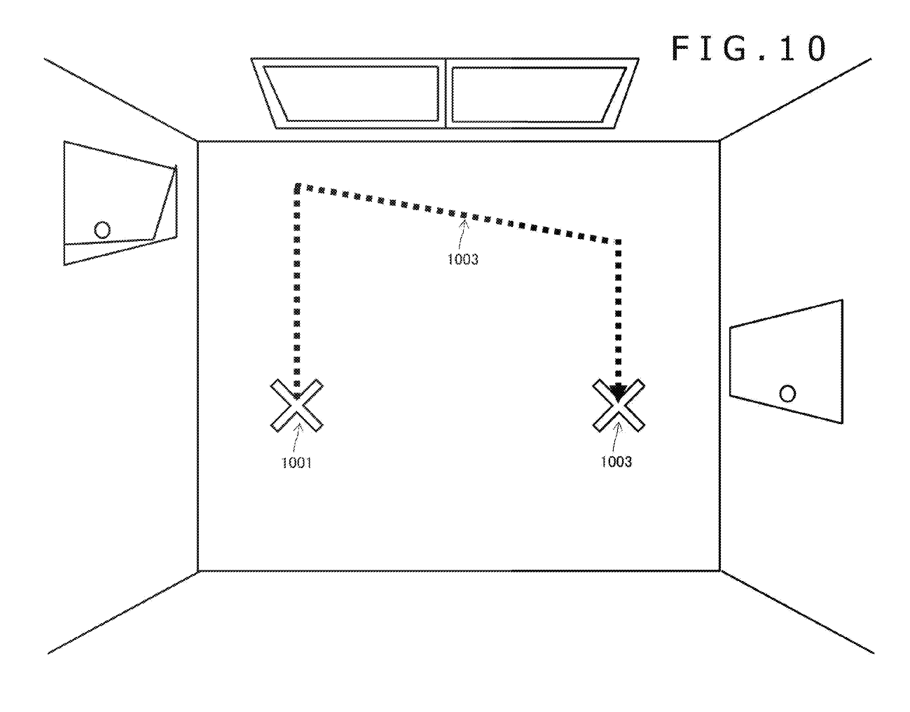

For example, in the case where an archive video to be switched is one taken with a start position being referenced by 1001 illustrated in FIG. 10, moving along a route referenced by 1002, ending at an end position referenced by 1003, switching from a real-time video being taken in the proximity of the reproduction start position 1001 of an archive video to this archive video enables the continuous switching between the videos by image synthesis or makes the video discontinuity within an allowable range for a viewer. Likewise, in switching from an archive video to a real-time video again, switching to the real-time video being taken in the proximity of the reproduction end position 1003 of the archive video enables the continuous video switching by image synthesis or makes the video discontinuity within an allowable range for a viewer.

Physically marking the reproduction start position 1001 and the reproduction end position 1003 on the floor or the like in a visually recognizable manner allows the user taking a real-time video to use these marks for video taking. Switching to an archive video when the user approaches each mark while walking around properties allows the viewing of the archive video continuously switched from the real-time video at the video reproducing apparatus side. However, it is unrealistic to arrange such marks as indicative of the positions 1001 and 1003 on real-estate properties. Further, if there are two or more archive videos of a property concerned, many marks need be arranged, thereby tarnishing the appearance and, at the same time, making it difficult to distinguish between the positions of one archive video from another.

Therefore, the following describes a technology of guiding the user of a video providing apparatus to proper video-taking positions when a video to be sent to a video reproducing apparatus is switched from a real-time video currently being taken with the video providing apparatus to an archive video taken and recorded in the past.

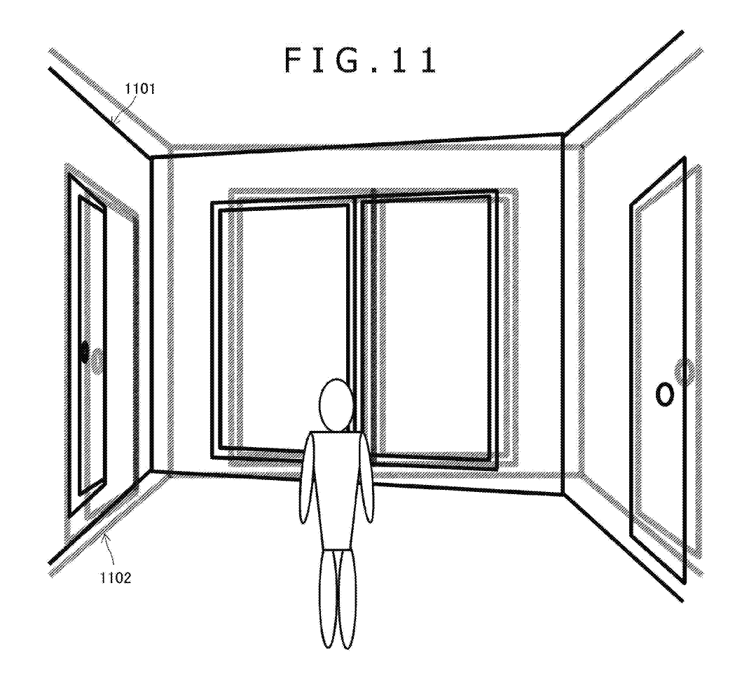

One example of the technology for guidance to proper video-taking positions is a method in which an archive video to be switched is image-synthesized with a real-time video currently being taken on the display block 510 of a video providing apparatus and the synthesized videos are displayed thereon. FIG. 11 illustrates an example in which a real-time video 1101 and an archive video 1102 are image-synthesized. The user of the video providing apparatus taking a real-time video searches for a position (a video-taking position) at which the real-time video is superimposed with an archive video. Then, in the distribution server, at the time when enough superimposition is obtained, switching to the archive video is executed, thereby allowing the video reproducing apparatus side to get continuous video viewing switched from the real-time video to the archive video.

For example, if the display block 510 (or the video providing apparatus itself) is configured as a transmission-type head-mounted display, a task of searching for a field of view in which the superimposition with the see-through-displayed archive video is obtained can locate a place suitable for switching to the archive video.

It should be noted that, in order to enhance the visual recognition of a real-time video beyond an archive video even after the execution of image synthesis, image processing such as edge processing or alpha blending may be executed on the archive video.

In addition, there is a situation in which, when a video with an archive video synthesized with a real-time video is suddenly presented, it is difficult to understand in which direction the archive video can be reached. Therefore, at the time when the synthesized image of an archive video is displayed, the audio output block 512 may be set up so as to output an audio guidance telling where to approach places in a room such as “a next room,” “go to the living room,” and “turn further right,” for example.

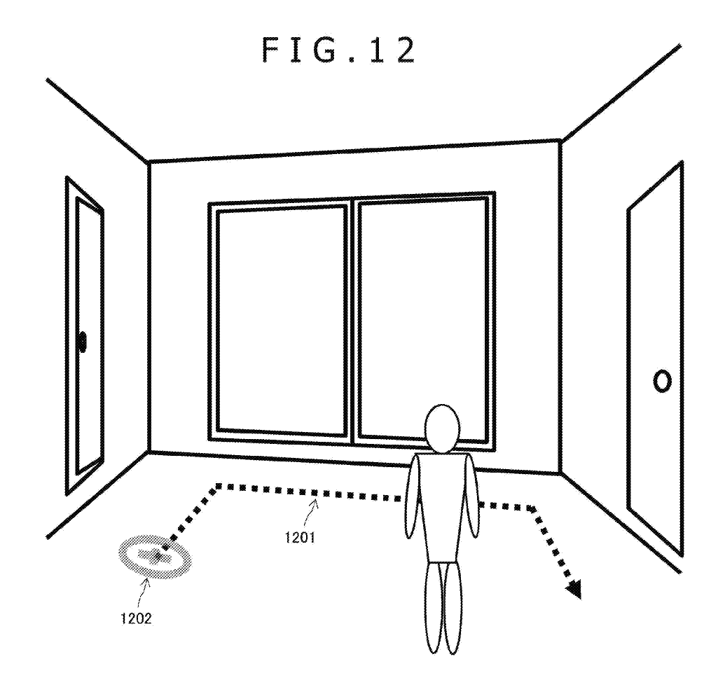

Further, another example of a technology of providing guidance to proper video-taking positions is a method visually presenting the information related with a travel locus at the time of taking an archive video. For example, as illustrated in FIG. 12, displaying a travel locus 1201 at the time of taking an archive video or a reproduction start position 1202 that is one end of the travel locus 1201 into a real-time video currently being taken by a video providing apparatus in a superimposed manner facilitates the user to understand where to advance at the time of switching to the archive video. The information associated with the reproduction start position 1202 may be displayed as an area within a range in which video switching is enabled (or switching is permitted) by image synthesis or the like rather than a point.

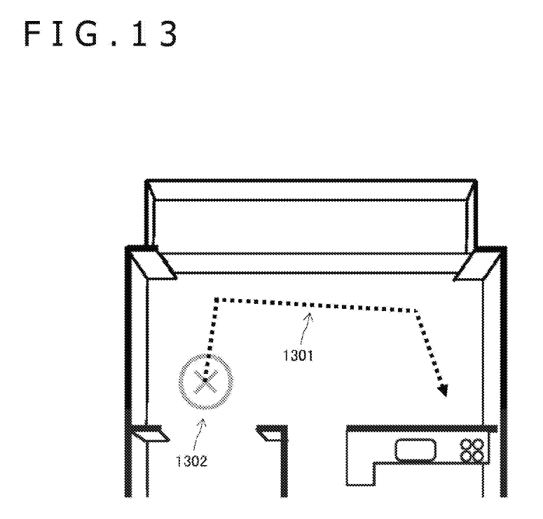

Alternatively, not displaying a travel locus as superimposed on a real-time video, but a travel locus 1301 and a reproduction start position marker 1302 may be displayed on the image of a map (a room layout or the like) as illustrated in FIG. 13.

However, presenting the information related with a travel locus as described above must record, as a precondition, the map of the travel locus of a camera (a video providing apparatus) at the time of taking an archive video. In addition, the method of presenting the information related with a travel locus is more difficult in realization than the method of overlay-displaying of the edge processed image or alpha-blended image of an archive video. In order to create a map, an algorithm such as SLAM (Simultaneous Localization and Mapping), for example, may be used.

It is necessary to correctly control a timing of switching from a real-time video to an archive video. This is because, even if the user of a video providing apparatus can be guided to a proper video-taking position by overlay-displaying an archive video and presenting a travel locus and a reproduction start position, if the switching takes place before traveling to that position or, conversely, video switching takes place at a position beyond that proper video-taking position, discontinuous video switching takes place on the video reproducing apparatus side.

Therefore, when the video providing apparatus has sufficiently approached the video-taking position, the switching from a real-time video to an archive video is executed. For example, a distribution server executes image matching between a real-time video being taken with a video providing apparatus and an archive video at the reproduction start position, thereby executing video switching with a timing with the matching sufficiently taken. However, even if a complete image matching is not provided, a range in which the continuous video switching can be done by image synthesis is allowable. Alternatively, the information associated with the current position of the video providing apparatus may be acquired so as to execute video switching with a timing when the reproduction start position of the archive video has been sufficiently approached. The current position of the video providing apparatus can be estimated by the SLAM technology by use of the real-time video taken with the image-taking block 501, for example.

This also applies to the case in which switching from an archive video to a real-time video is executed again. For example, by executing image matching between the real-time video being taken with the video providing apparatus and an archive video at a reproduction end position, video switching is executed with a timing when enough matching is obtained. However, even if a complete image matching is not provided, a range in which the continuous video switching can be done by snapping processing or image synthesis is allowable. Alternatively, the information associated with the current position of the video providing apparatus may be acquired so as to execute video switching with a timing when the reproduction end position of the archive video has been sufficiently approached. Even if the archive video has reached the reproduction end position, when the video providing apparatus is not in the proximity thereof, switching to the real-time video must not be executed. In such a case, a distribution server may pause the reproduction of the archive video at the video reproducing apparatus, thereby putting the switching in wait state until the video providing apparatus gets to a proper position or continuing the reproduction of the archive video also after a scheduled reproduction end position. In the latter, switching to the real-time video may be executed with, for example, a timing when image matching is provided between the real-time video being taken with the video providing apparatus and the archive video at the current reproduction position.

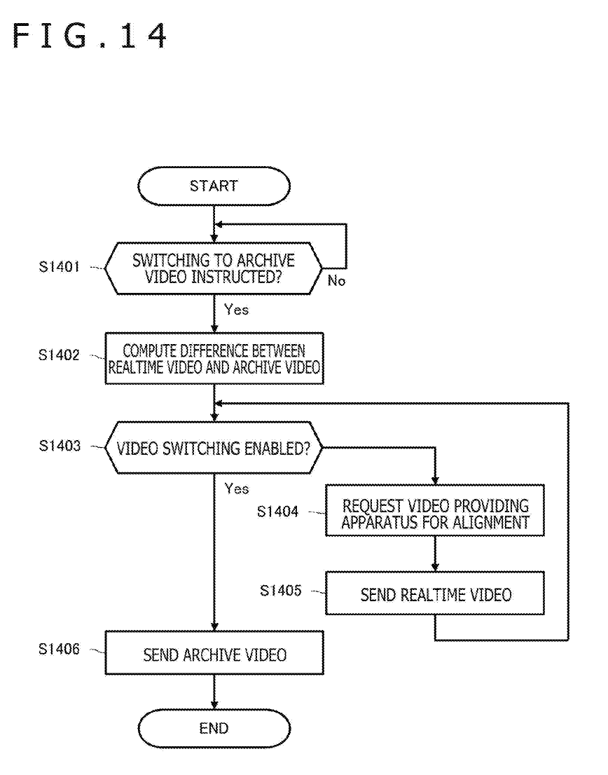

FIG. 14 depicts a flowchart indicative of a processing procedure that is executed by a distribution server in switching a video to be displayed on a video reproducing apparatus from a real-time video to an archive video. The illustrated processing procedure is assumed to be executed during the distribution of a real-time video to the video reproducing apparatus.

If an instruction for switching to an archive video is issued from a video reproducing apparatus, a video providing apparatus, or the like during the distribution of a real-time video from a distribution server to the video reproducing apparatus (Yes in step S1401), then the distribution server reads a video at a reproduction start position of the requested archive video and computes a difference from the real-time video (step S1402), thereby checking whether the switching from the archive video to the real-time video is enabled or not (step S1403).

If the difference between the real-time video and the archive video at the reproduction start position is equal to or less than a predetermined value, then it is determined that the switching from the archive video to the real-time video is enabled (Yes in step S1403). For example, if a distance between the video-taking position of the real-time video and the video-taking position of the archive video is about several tens centimeters, then it can be determined that continuous video switching by snapping processing, image synthesis (if three-dimensional measurement is enabled, the videos are three-dimensionally re-synthesized), or animation is permitted or the discontinuity between videos is within an allowable range for a viewer, and therefore the switching from the real-time video to the archive video is enabled.

On the other hand, if the difference the real-time video and the archive video at the reproduction start position is higher than the predetermined value, then it is determined that the switching from the real-time video to the archive video is disabled (step S1403). In this case, the distribution server requests the video providing apparatus for the alignment of the real-time video (step S1404). This request is accompanied with the information such as the video at the reproduction start position of the archive video. Then, while the alignment processing on the real-time video is executed by the video providing apparatus, the distribution server stops the switching to the archive video, continuing the distribution of the real-time video sent from the video providing apparatus to the video reproducing apparatus (step S1405).

Then, when the difference between the real-time video and the archive video at the reproduction start position finally gets equal to or less than the predetermined value and the switching from the real-time video to the archive video is enabled (Yes in step S1403), the distribution server switches the distribution video to the video reproducing apparatus from the real-time video to the archive video (step S1406).

It should be noted that, if the distribution of the real-time video is restored after the switching to the archive video, the distribution server requests the video providing apparatus for the alignment of the real-time video and continues the transmission of the archive video to the video reproducing apparatus until the difference between the real-time video and the archive video at the reproduction start position gets equal to or less than the predetermined value and the switching to the real-time video is enabled.

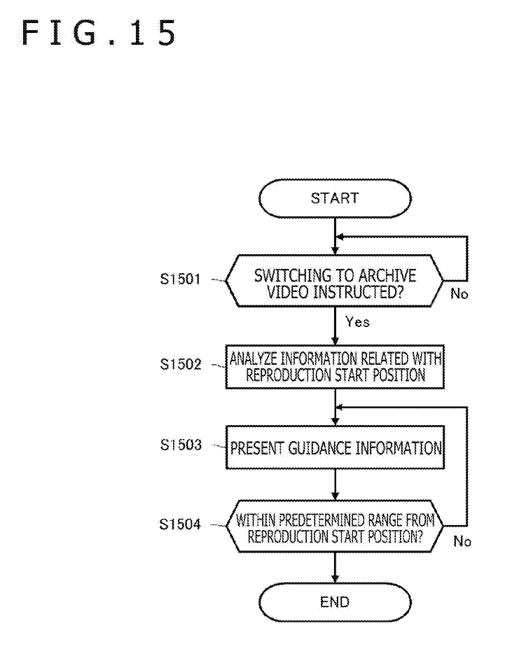

FIG. 15 illustrates, in the form of a flowchart, a processing procedure by the video providing apparatus for aligning, in switching a video to be displayed on a video reproducing apparatus from a real-time video to an archive video, the real-time video with a video at a reproduction start position of the archive video. The illustrated processing procedure is assumed to be executed during the taking and transmission of a real-time video by a video providing apparatus.

When an instruction of switching to an archive video is inputted in a video providing apparatus from a user or an instruction of switching to an archive video comes via a distribution server (Yes in step S1501), a video at a reproduction start position of the archive video is acquired and analyzed (Yes in step S1502). The video at the reproduction start position of the archive video may be acquired from a distribution server or the archive videos stored by the video providing apparatus itself.

Next, guidance information for guiding the user of the video providing apparatus to a proper video-taking position is presented (step S1503).

Guidance information presentation methods are various. It is also practicable to superimpose a video at the reproduction start position of an archive video with a real-time video and display the superimposed video on the display block 510. For example, if the display block 510 (or the video providing apparatus itself) is configured as a transmission-type head-mounted display, the video at the reproduction start position of an archive video may be displayed in a see-through manner. However, image processing such as edge processing or alpha blending may be executed on the video at the reproduction start position so as to make a real-time video easily visually recognizable over an archive video (refer to FIG. 11).

Alternatively, a video providing apparatus may output audio guidance from the audio output block 512, telling which part in the room to approach. It is also practicable to execute audio guidance along with the superimposed display (described above) of the video at the reproduction start position.

Alternatively, it is practicable to display, on the display block 510, a travel locus at the time of taking an archive video and the information associated with a reproduction start position that is one end of the travel locus as superimposed with a real-time video.

Until the difference between the real-time video and the video at the reproduction start position of the archive video gets within a predetermined range, thereby enabling switching to the archive video (No in step S1504), the processing procedure is returned to step 51503 to continue the presentation of the guidance information. In addition, the contents of the guidance information are updated as required.

Then, when the difference between the real-time video and the video at the reproduction start position of the archive video gets within a predetermined range, thereby enabling switching to the archive video (Yes in step S1504), the video providing apparatus ends this processing.

It should be noted that, if, after switching to an archive video, the distribution of a real-time video is restored again, the video providing apparatus executes the similar presentation of the guidance information as described above for guiding the alignment between the video at the reproduction end position of the archive video and the real-time video.

According to the technology disclosed herein, the transmission of videos of real-estate properties, for example, can be suitably controlled. Further, according to the technology disclosed herein, real-time videos or archive videos of real-estate properties, for example, can be suitably viewed, thereby realizing the private viewing with a sense of reality even at locations remote from properties.

### INDUSTRIAL APPLICABILITY

While preferred embodiments of the present invention have been described using specific terms, such description is for illustrative purpose only, and it is to be understood by those skilled in the art that changes and variations may be made without departing from the spirit or scope of the following claims.

In the present description, embodiments in which the technology disclosed herein is applied to a real-estate property private viewing system have mainly been described; however, the gist of the technology disclosed herein is not limited thereto. The technology disclosed herein is applicable to the video transmission in a variety of industrial fields. For example, the technology disclosed herein is applicable to the task support, care support, and temporary staffing in a variety of industrial fields, such as medial practices including surgical operation, building practices including civil engineering, operations of aircraft and helicopter, navigation for car drivers, and instruction and coaching of sports. In addition, the technology disclosed herein is useful in concert and sport watching and SNS (Social Network Services).

In its essence, the technology disclosed herein has been described only as illustrative and therefore the contents hereof should not be interpreted as restrictive. For the judgment of the gist of the technology disclosed herein, the scope of claims should be put into consideration.

It should be noted that the technology disclosed herein may take the following configuration.

(1) An information processing terminal apparatus including:

an image-taking block;

a sending block configured to send an image taken by the image-taking block; and

a control block,

in which the control block controls alignment between a current image currently being taken by the image-taking block and a past image taken in a past.

(2) The information processing terminal apparatus according (1) above, further including:

a display block,

in which the control block makes the display block display information for alignment with the past image.

(3) The information processing terminal apparatus according to (2) above,

in which the control block makes the display block display the past image and the current image by superimposing the past image with the current image.

(4) The information processing terminal apparatus according to (2) above,

in which the control block makes the display block display the past image on which any one of edge processing, alpha blending processing, or other image processing is executed by superimposing the past image with the current image.

(5) The information processing terminal apparatus according to (2) above,

in which the control block makes the display block display information related with a travel locus at taking the past video.

(6) A distribution apparatus including:

a sending block configured to send an image taken by a first apparatus to a second apparatus; and

a control block configured to control image transmission by the sending block,

in which the control block controls distributed-image switching between a current image currently being taken and a past image taken in a past by the first apparatus.

(7) The distribution apparatus according to (6) above,

in which the control block controls the distributed-image switching in accordance with a difference between the current image and the past image.

(8) The distribution apparatus according to (6) above,

in which the control block does not execute the distributed-image switching until a difference between the current image and the past image gets within a predetermined range.

(9) The distribution apparatus according to (6) above,

in which the control block executes the distributed-image switching by interconnecting the current image and the past image by use of any one of snapping, image synthesis, or animation when a difference between the current image and the past image gets within a predetermined range.

### REFERENCE SIGNS LIST

100 . . . Video viewing system

101 . . . Video providing apparatus, 102 . . . Video reproducing apparatus

200 . . . Video viewing system

201 . . . Video providing apparatus, 202 . . . Video reproducing apparatus

300 . . . Video viewing system

301 . . . Video providing apparatus, 302 . . . Video reproducing apparatus

400 . . . Video viewing system

401 . . . Video providing apparatus, 402 . . . Video reproducing apparatus

500 . . . Information processing apparatus (video providing apparatus)

501 . . . Image-taking block, 503 . . . Video encoding block

504 . . . Audio input block, 505 . . . Audio encoding block

506 . . . Multiplexing block, 507 . . . Communication block,

508 . . . Video decoding block

509 . . . Image processing block, 510 . . . Display block,

511 . . . Audio decoding block

512 . . . Audio output block, 513 . . . Control block

600 . . . Information processing apparatus (video reproducing apparatus)

601 . . . Communication block, 602 . . . Demultiplexer (DEMUX)

603 . . . Audio decoding block, 604 . . . Audio output block

605 . . . Video decoding block, 606 . . . Display block

607 . . . Sound pickup block, 608 . . . Audio encoding block,

609 . . . Sensor block

610 . . . Control block, 611 . . . External device interface

1. An information processing terminal apparatus comprising:
an image-taking block;
a sending block configured to send an image taken by the image-taking block; and
a control block,
wherein the control block controls alignment between a current image currently being taken by the image-taking block and a past image taken in a past.

2. The information processing terminal apparatus according to claim 1, further comprising:
a display block,
wherein the control block makes the display block display information for alignment with the past image.

3. The information processing terminal apparatus according to claim 2,
wherein the control block makes the display block display the past image and the current image by superimposing the past image with the current image.

4. The information processing terminal apparatus according to claim 2,
wherein the control block makes the display block display the past image on which any one of edge processing, alpha blending processing, or other image processing is executed by superimposing the past image with the current image.

5. The information processing terminal apparatus according to claim 2,
wherein the control block makes the display block display information related with a travel locus at taking the past video.

6. A distribution apparatus comprising:
a sending block configured to send an image taken by a first apparatus to a second apparatus; and
a control block configured to control image transmission by the sending block,
wherein the control block controls distributed-image switching between a current image currently being taken and a past image taken in a past by the first apparatus.

7. The distribution apparatus according to claim 6,
wherein the control block controls the distributed-image switching in accordance with a difference between the current image and the past image.

8. The distribution apparatus according to claim 6,
wherein the control block does not execute the distributed-image switching until a difference between the current image and the past image gets within a predetermined range.

9. The distribution apparatus according to claim 6,
wherein the control block executes the distributed-image switching by interconnecting the current image and the past image by use of any one of snapping, image synthesis, or animation when a difference between the current image and the past image gets within a predetermined range.
